(19) United States
(12) Patent Application Publication
(10) Pub. No.: US 2026/0257646 A1
(43) Pub. Date: Sep. 3, 2026

(54) FREIGHT VEHICLE AND ON-BOARD GOODS SAFETY PROTECTION SYSTEM

(71) Applicant: THE THIRD RESEARCH INSTITUTE OF MINISTRY OF PUBLIC SECURITY, Shanghai (CN)

(72) Inventor: Caixia Liu, Shanghai (CN)

(21) Appl. No.: 18/833,317

(22) PCT Filed: Nov. 4, 2022
(86) PCT No.: PCT/CN2022/129885

§ 371 Date: Jul. 25, 2024

(30) Foreign Application Priority Data
Jun. 7, 2022 (CN) 202210642187.X

(51) Int. Cl. B60R 25/102; B60R 25/01; B60R 25/30; B60R 25/33

(52) U.S. Cl. CPC B60R 25/102; B60R 25/018; B60R 25/305; B60R 25/33

(57) ABSTRACT

The present invention discloses a safety protection system for a freight automobile and on-board goods. The system includes an anti-theft and anti-robbery monitoring and warning unit, an on-board gateway unit, an alarm prompt unit, and a remote management unit. Through the anti-theft and anti-robbery monitoring and warning unit, the system can automatically monitor anti-theft and anti-robbery safety information of the on-board goods in real time, perform theft and robbery risk warning analysis on the vehicle loaded with goods and the goods on the vehicle directly or in cooperation with the on-board gateway unit based on the monitored information, generate warning information for a risk, send the warning information to the remote management unit through the on-board gateway unit, and send a warning through the alarm prompt unit. The system can realize comprehensive anti-theft and anti-robbery safety protection and control on freight automobiles and comprehensive safety monitoring on on-board goods.

### CROSS-REFERENCE TO RELATED APPLICATIONS

The present application is a National Stage application of PCT international application: PCT/CN 2022/129885, filed on 4 Nov. 2022, the disclosure of which is hereby incorporated by reference in its entirety.

### TECHNICAL FIELD

The present invention relates to vehicle safety technologies, and in particular, to a safety protection and control technology for a freight automobile and on-board goods.

### BACKGROUND

A freight vehicle is a kind of vehicle designed and equipped mainly for carrying goods. At present, the safety monitoring of freight vehicles carrying goods mainly focuses on the monitoring of vehicle running status, such as speed and positioning. However, the carried goods cannot be effectively monitored. In this way, when the goods carried by the freight vehicle is lost, it is often not found in time. When the freight vehicle or the carried goods are stolen and robbed, especially when stolen and robbed in a remote section or a sparsely populated area, it is difficult to obtain timely rescue, resulting in irreparable losses. Moreover, if vehicles carrying inflammable, explosive, highly corrosive, toxic, and radioactive dangerous goods or their on-board goods are stolen and robbed by criminals and used in terrorist activities, and cannot be found in time and stopped as soon as possible, it will bring great potential safety hazards to society.

Therefore, how to effectively monitor the safety of freight automobiles and on-board goods during transportation to ensure the transportation safety of freight automobiles is an urgent problem in this field.

### SUMMARY

In view of the problems existing in the safety supervision of existing freight automobiles, a technical solution that can comprehensively monitor safety of freight automobiles and goods carried thereon is required.

In view of this, an object of the present invention is to provide a safety protection system for a freight automobile and on-board goods. The system can realize comprehensive anti-theft and anti-robbery and anti-lost monitoring on the freight automobile and on-board goods during transportation, thereby effectively improving transportation safety of freight vehicles.

In order to achieve the above object, the safety protection system for a freight automobile and on-board goods provided in the present invention includes:
an anti-theft and anti-robbery monitoring and warning unit, where the anti-theft and anti-robbery monitoring and warning unit is associated with an on-board gateway unit, and is associated with an alarm prompt unit and a remote management unit through the on-board gateway unit; and the anti-theft and anti-robbery monitoring and warning unit is configured to: monitor anti-theft and anti-robbery safety information of the on-board goods in real time, perform theft and robbery risk warning analysis on the vehicle loaded with goods and the goods on the vehicle directly or in cooperation with the on-board gateway unit based on the monitored information, generate warning information for a risk, send the warning information to the remote management unit through the on-board gateway unit, and send a warning through the alarm prompt unit;
the on-board gateway unit, where the on-board gateway unit is respectively associated with the anti-theft and anti-robbery monitoring and warning unit, the alarm prompt unit, and the remote management unit, and establishes a communication channel with the units to complete data exchange, and the on-board gateway unit is configured to store data information acquired by functional modules of the on-board gateway unit and complete the risk warning analysis based on the relevant data information in cooperation with the anti-theft and anti-robbery monitoring and warning unit;
the alarm prompt unit, where the alarm prompt unit is connected to the on-board gateway unit, and is configured to complete a local alarm on the automobile and/or complete a remote alarm through the remote management unit associated with the on-board gateway unit; and
the remote management unit, where the remote management unit is associated with the on-board gateway unit, and is indirectly associated with the anti-theft and anti-robbery monitoring and warning unit and the alarm prompt unit through the on-board gateway unit, and the remote management unit is configured to form system configuration information and/or emergency handling information, and is further configured to receive physical and chemical safety monitoring information and on-board goods anti-theft and anti-robbery monitoring and warning information sent by the on-board gateway unit.

Further, the anti-theft and anti-robbery monitoring and warning unit includes an automobile anti-theft alarm module, an automobile anti-robbery monitoring module, an automobile anti-theft and anti-robbery positioning and tracking module, a vehicle fuel tank safety monitoring module, an access intrusion detection module, a goods anti-theft video monitoring module, and/or an automatic goods inventory module.

Further, the automobile anti-theft alarm module is configured to monitor an illegal position movement or an abnormal start of the vehicle in a parked state, and transmit the monitoring information to a data storage module and an edge computing module of the on-board gateway unit or to the remote management unit through a network communication module of the on-board gateway unit.

Further, the automobile anti-robbery monitoring module is configured to monitor conditions such as an armed person around the vehicle and gathering of abnormal persons, and transmit the monitoring information to the data storage module and the edge computing module of the on-board gateway unit or to the remote management unit through the network communication module of the on-board gateway unit.

Further, the automobile anti-theft and anti-robbery positioning and tracking module is configured to position and track a real-time position of the vehicle after an anti-theft and anti-robbery alarm is triggered, and transmit the tracked positioning information to the remote management unit through the network communication module of the on-board gateway unit.

Further, the vehicle fuel tank safety monitoring module is configured to perform real-time video monitoring on a position of a fuel tank of the freight vehicle loaded with goods, and transmit the monitoring information to the data storage module and the edge computing module of the on-board gateway unit or to the remote management unit through the network communication module of the on-board gateway unit.

Further, the access intrusion detection module is configured to monitor a compartment door of the freight vehicle loaded with goods or an oil pump inlet and outlet pipeline/oil drain valve of a tank car, and transmit the monitoring information to the data storage module and the edge computing module of the on-board gateway unit or to the remote management unit through the network communication module of the on-board gateway unit.

Further, the goods anti-theft video monitoring module is configured to perform video monitoring on a goods condition inside a closed van loaded with goods and all openings of the tank car, and transmit the monitoring information to the data storage module and the edge computing module of the on-board gateway unit or to the remote management unit through the network communication module of the on-board gateway unit.

Further, the automatic goods inventory module is configured to record a change in a number of goods during loading and unloading in real time, perform regular or irregular inventory on a number of carried goods, and transmit recording and inventory information to the data storage module and the edge computing module of the on-board gateway unit or to the remote management unit through the network communication module of the on-board gateway unit.

Further, the automobile anti-theft alarm module of the anti-theft and anti-robbery monitoring and warning unit includes, but is not limited to a direct contact sensor and/or a current and voltage drop sensor and/or an ultrasonic sensor and/or a microwave sensor and/or a shock sensor and/or a tilt sensor.

The direct contact sensor is configured to trigger an alarm when a door, a trunk, a rear hatch, or the like is forced open.

The current and voltage drop sensor is configured to monitor a change in a vehicle circuit system, and trigger an alarm when the vehicle circuit system changes.

The ultrasonic sensor is configured to monitor a change in air pressure in a vehicle cab and trigger an alarm when a window is broken or someone enters the vehicle cab when the vehicle is parked.

The microwave sensor is configured to monitor solid objects passing through light beams emitted from all entry points in the vehicle cab, and trigger an alarm when someone enters the vehicle cab when the vehicle is parked.

The shock sensor is configured to monitor a sudden shock of the vehicle, and trigger an alarm when someone tries to smash glass and enter the vehicle cab or destroy the vehicle.

The tilt sensor is configured to monitor a sudden tilt of the vehicle, and trigger an alarm when someone tries to tow the vehicle away.

Further, the automobile anti-robbery monitoring module of the anti-theft and anti-robbery monitoring and warning unit includes, but is not limited to an exterior video monitoring device, a concealed alarm button, a wireless transmitting pinhole camera, a warning light, an exterior tear gas sprayer, and another self-defense weapon.

The exterior video monitoring device is configured to acquire an image of a person around the vehicle, and trigger an alarm when a plurality of persons approach with weapons or abnormal persons gather.

The concealed alarm button is configured to send a robbery emergency alarm when a driver has confirmed that a robbery event occurs.

The wireless transmitting pinhole camera is configured to acquire behavior images of robbers outside the vehicle when the robbery emergency alarm is triggered.

The exterior tear gas sprayer is configured to automatically release commonly used tear sprays such as o-chlorobenzylidene malononitrile (CS) and/or chloroacetophenone (CN) and/or capsaicine (OC) when the robbery emergency alarm is triggered, which produce strong stimulation to eyes, noses, mouths, skin, and respiratory tract sense organs of gangsters at a robbery site.

The warning light is configured to continuously flash on a roof of the vehicle when an emergency alarm is triggered, so as to deter the gangsters at the robbery site and guide vehicle positions for policemen who are rushing to the robbery site.

The another self-defense weapon includes, but is not limited to a strong flashlight, an expandable baton, a flash bomb, or a small dry powder fire extinguisher, and is configured to trigger the driver and passenger to delay the robbery action of the gangster during the robbery emergency alarm, which improves a sense of security and self-defense ability of the driver and passenger.

Further, the automobile anti-theft and anti-robbery positioning and tracking module of the anti-theft and anti-robbery monitoring and warning unit includes, but is not limited to a deep sleep tracking locator, a solar charger, and an infrared pinhole camera at an automobile driver position.

The deep sleep tracking locator is configured to start real-time positioning after the vehicle is stolen and robbed and a satellite positioning system of an on-board terminal unit is destroyed or powered off. The tracking locator includes but is not limited to Beidou satellite positioning and/or GPS positioning and/or GLONASS positioning and/or GSNS satellite positioning.

The solar charger is configured to charge the deep sleep tracking locator to ensure that the deep sleep tracking locator is in an operating state after being started.

The infrared pinhole camera at the automobile driver position is configured to acquire an image of a person at the automobile driver position in real time after the deep sleep tracking locator is started.

Further, the vehicle fuel tank safety monitoring module of the anti-theft and anti-robbery monitoring and warning unit includes but is not limited to an infrared detector and a vibration sensor arranged on a fuel tank cap, a liquid level sensor arranged in a fuel tank, and/or an infrared pinhole camera configured to monitor a position of the fuel tank in real time.

The infrared detector is configured to detect a person approaching the oil tank in an armed state without needing to refuel the oil tank, and trigger an alarm when a person enters a detection area in the armed state. The infrared detector includes a passive infrared detector or an active infrared detector.

The vibration sensor is configured to detect abnormal vibration of the fuel tank cap in the armed state without needing to refuel the fuel tank, and trigger an alarm when the fuel tank cap vibrates in the armed state.

The liquid level sensor in the fuel tank is configured to detect an abnormal drop of a gasoline or diesel liquid level in the fuel tank, and trigger an alarm when the oil level drops rapidly in the armed state.

The infrared pinhole camera that can monitor the position of the fuel tank in real time is configured to acquire an image of a person approaching the fuel tank in the armed state without needing to refuel the fuel tank, and start the camera when a vehicle fuel tank safety monitoring alarm is triggered.

Further, the access intrusion detection module of the anti-theft and anti-robbery monitoring and warning unit includes but is not limited to an access controller, a passive infrared intrusion detector and/or an active infrared intrusion detector and/or a microwave intrusion detector and/or a radar microwave detector and/or a switch detector and/or an ultrasonic detector and/or a voice control detector and/or a wireless magnetic switch detector, a vibration sensor, and a pinhole camera configured to monitor a position of a compartment door of the freight vehicle or an oil pump inlet and outlet pipeline/oil drain valve of a tank car in real time, which are arranged on the compartment door of the freight vehicle carrying goods or the oil pump inlet and outlet pipeline/oil drain valve of the tank car.

The access controller is configured to control opening and closing of the compartment door of the freight vehicle carrying goods or the oil pump inlet and outlet pipeline/oil drain valve of the tank car, and trigger an alarm when abnormal opening occurs.

The passive infrared intrusion detector and/or the active infrared intrusion detector and/or the microwave intrusion detector and/or the radar microwave detector and/or the switch detector and/or the ultrasonic detector and/or the voice control detector and/or the wireless magnetic switch detector is configured to detect abnormal approaching of a person or abnormal opening of the compartment door, the inlet and outlet pipeline/oil drain valve in the armed state, and trigger an alarm when the abnormal approaching of the person or abnormal opening of the compartment door and the inlet and outlet pipeline/oil drain valve occurs in the armed state.

The vibration sensor is configured to detect abnormal vibration of the compartment door and the inlet and outlet pipeline/oil drain valve in the armed state, and trigger an alarm when vibration of the compartment door and the inlet and outlet pipeline/oil drain valve occurs in the armed state.

The pinhole camera at the position of the compartment door of the freight vehicle or the oil pump inlet and outlet pipeline/oil drain valve of the tank car is configured to acquire an image of a person approaching the compartment door and the inlet and outlet pipeline/oil discharge valve in the armed state, and start the camera when an access intrusion monitoring alarm is triggered.

Further, the goods anti-theft video monitoring module of the anti-theft and anti-robbery monitoring and warning unit includes a goods image monitoring camera arranged above four corners in a compartment and a process monitoring camera arranged in the compartment exactly facing the compartment door.

The goods image monitoring camera is arranged above four corners of the compartment and configured to acquire a real-time image after goods are loaded.

The process monitoring camera is arranged at a position in the compartment that exactly faces the compartment door and configured to acquire images during goods loading and unloading.

Further, the automatic goods inventory module of the anti-theft and anti-robbery monitoring and warning unit includes a code scanner or a radio frequency identification (RFID) reader arranged at the compartment door, a barcode label, a two-dimensional code label, or a radio frequency identification (RFID) label installed or pasted on a goods package.

The code scanner or the radio frequency identification (RFID) reader is configured to read the barcode label, the two-dimensional code label, or the radio frequency identification (RFID) label on the goods package.

The barcode label, the two-dimensional code label, or the radio frequency identification (RFID) label is configured to be pasted on the goods package for reading and statistics during loading and unloading.

The combined configuration of the radio frequency identification (RFID) reader and the radio frequency identification (RFID) label may further be used for regular or irregular inventory during transport.

Further, the anti-theft and anti-robbery monitoring and warning unit is directly associated with the on-board gateway unit, and indirectly associated with a vehicle alarm prompt unit and the remote management unit through the on-board gateway unit. Various monitoring devices, detection devices, and cameras of the automobile anti-theft alarm module, the automobile anti-robbery monitoring module, the automobile anti-theft and anti-robbery positioning and tracking module, the vehicle fuel tank safety monitoring module, the access intrusion detection module, the goods anti-theft video monitoring module, and/or the automatic goods inventory module of the anti-theft and anti-robbery monitoring and warning unit aggregate the monitoring data to the data storage module of the on-board gateway unit through the network communication module of the on-board gateway unit, and intelligent analysis is performed through the edge computing module of the on-board gateway unit. When the corresponding anti-theft and anti-robbery warning is triggered, a corresponding acousto-optic alarm or a voice prompt is sent to the alarm prompt unit through the network communication module of the on-board gateway unit, and the alarm prompt information is uploaded to the remote management unit through the network communication module of the on-board gateway unit.

Further, the on-board gateway unit includes a network communication module and/or a data storage module and/or an edge computing module.

The network communication module is configured for data exchange between the anti-theft and anti-robbery monitoring and warning unit and the alarm prompt unit and the remote management unit, and is configured to forward the monitoring information uploaded by the anti-theft and anti-robbery monitoring and warning unit and the analysis result to the remote management unit, or based on the received command of the remote management unit, forward an alarm command and voice prompt command information to the alarm prompt unit, and forward command information such as alarm threshold setting adjustment and circuit control to the relevant monitoring device of the anti-theft and anti-robbery monitoring and warning unit.

The data storage module is configured to store the monitoring information uploaded by the anti-theft and anti-robbery monitoring and warning unit.

The edge computing module is configured to perform intelligent analysis and determination based on the monitoring information uploaded by the anti-theft and anti-robbery monitoring and warning unit.

Further, the on-board gateway unit is directly associated with the anti-theft and anti-robbery monitoring and warning unit, the alarm prompt unit, and the remote management unit. When the on-board gateway unit receives the monitoring information of the anti-theft and anti-robbery monitoring and warning unit and analyzes and determines that a relevant warning and alarm indicating that goods are stolen and robbed is triggered, the on-board gateway unit sends an acousto-optic alarm or voice prompt information to the alarm prompt unit and sends warning and alarm information and real-time monitoring information to the remote management unit. When receiving an alarm command, a voice prompt command, or an alarm threshold setting adjustment sent by the remote management unit, the on-board gateway unit sends the alarm command and the voice prompt command information to the alarm prompt unit, sends command information such as the alarm threshold setting adjustment and circuit control to a relevant monitoring device of the anti-theft and anti-robbery monitoring and warning unit to perform a relevant operation such as adjusting an alarm threshold of a monitoring sensor and starting the positioning and tracking device or a related pinhole camera, and sends voice broadcast information of the emergency rescue guide to a voice broadcast module of a goods transportation emergency rescue guide unit to guide the driver and passenger to provide a preliminary emergency response.

Further, the alarm prompt unit includes vehicle local alarm prompt subunits such as an internal cab acousto-optic alarm module, an internal cab voice prompt module, an external cab acousto-optic alarm module, and an external cab voice prompt module, and remote monitoring client software alarm prompt subunits such as a government industry management client software, an enterprise operation management client software, and a driver and passenger service client software.

Further, the alarm prompt unit is directly associated with the on-board gateway unit, and indirectly associated with the anti-theft and anti-robbery monitoring and warning unit and the remote management unit through the on-board gateway unit. When the local alarm prompt subunit receives on-board goods anti-theft and anti-robbery monitoring and warning information with a medium risk level or a low risk level sent by the on-board gateway unit, the alarm prompt unit sends an internal cab acousto-optic alarm and a voice prompt to prompt the driver to stop nearby or stop immediately for inspection. When the local alarm prompt subunit receives high-risk-level on-board goods anti-theft and anti-robbery monitoring and warning information, the alarm prompt unit sends internal cab and external cab acousto-optic alarms and internal cab and external cab voice prompts to prompt the driver to stop immediately for inspection and to prompt passers-by to be alert for abnormal vehicles, avoid in time, or give an alarm immediately or warn gangsters who are in the state of theft and robbery to stop criminal acts. When the remote monitoring client software alarm prompt subunit receives the on-board goods anti-theft and anti-robbery monitoring and warning information with a medium risk level or a low risk level, the alarm prompt unit sends an alarm prompt. When the remote monitoring client software alarm prompt subunit receives the high-risk-level on-board goods anti-theft and anti-robbery monitoring and warning information, the alarm prompt unit sends an emergency alarm and voice prompt, sends emergency rescue guide information, and starts an emergency management process according to the emergency plan by default.

Further, the remote management unit includes
a government industry management client software, an enterprise operation management client software, a driver and passenger service client software, and a communication center.

The government industry management client software is configured to: receive and display high-risk-level automobile and on-board goods anti-theft and anti-robbery monitoring and warning information forwarded by the anti-theft and anti-robbery monitoring and warning unit through the on-board gateway unit and the communication center, send a relevant management command based on the received warning and alarm information, start an emergency management process, and issue a relevant emergency response command.

The enterprise operation management client software is configured to: receive and display automobile and on-board goods anti-theft and anti-robbery monitoring and warning information forwarded by the anti-theft and anti-robbery monitoring and warning unit through the on-board gateway unit and the communication center, send a relevant management command or emergency rescue guide information based on the received warning and alarm information, and start an emergency management process, give an emergency alarm, and issue a relevant emergency response command to the government industry management client when receiving the high-risk-level automobile and on-board goods anti-theft and anti-robbery monitoring and warning information.

The driver and passenger service client software is configured to: receive and display the automobile and on-board goods anti-theft and anti-robbery monitoring and warning information forwarded by the anti-theft and anti-robbery monitoring and warning unit through the on-board gateway unit and the communication center, send an acousto-optic alarm, a voice prompt, and an emergency rescue guide corresponding to the alarm and warning information based on the received alarm and warning information, prompt a driver to stop nearby or stop immediately for inspection, and provide a corresponding emergency response guideline.

The communication center is configured to communicate with the on-board gateway unit, receive and store the automobile and on-board goods anti-theft and anti-robbery monitoring and warning information forwarded by the anti-theft and anti-robbery monitoring and warning unit through the on-board gateway unit, and forward the automobile and on-board goods anti-theft and anti-robbery monitoring and warning information to the government industry management client software, the enterprise operation management client software, and the driver and passenger service client software respectively. The communication center also serves as a computer system environment for government industry management client software, the enterprise operation management client software, and the driver and passenger service client software, supports related software applications, and forwards management commands or reply commands of the government industry management client software, the enterprise operation management client software, and the driver and passenger service client software to the on-board gateway unit.

Further, the remote management unit is arranged on a cloud platform of a competent government department related to vehicle traffic management or operation management and/or a local storage server and/or a personal hand-held intelligent terminal of a relevant management person, a cloud platform of a transportation enterprise to which the vehicle belongs and a transportation-related party and/or a local storage server and/or a personal hand-held intelligent terminal of a relevant management person, and a personal hand-held intelligent terminal of a driver and passenger, is associated with the on-board gateway unit, and is indirectly associated with the anti-theft and anti-robbery monitoring and warning unit and the alarm prompt unit through the on-board gateway unit. The remote management unit receives the on-board goods anti-theft and anti-robbery monitoring and warning information sent by the on-board gateway unit, provides a driver management operation command based on the alarm information, and feeds back the driver management operation command to the on-board gateway unit and to the alarm prompt unit through the on-board gateway unit. The remote management unit supports setting and adjusting a warning and alarm threshold and an information uploading frequency of the relevant monitoring device of the anti-theft and anti-robbery monitoring and warning unit through the relevant monitoring client software, and pushes emergency rescue guide information for goods transport.

The safety protection system for a freight automobile and on-board goods provided in the present invention can monitor conditions such as illegal position movement or an abnormal start in a parked state of the vehicle, the armed person around the vehicle, and gathering of abnormal persons, synchronously locate and track a real-time position of the vehicle after an anti-theft and anti-robbery alarm is triggered, perform real-time video monitoring on a position of the fuel tank of the freight vehicle loaded with goods, a goods condition inside a closed van loaded with goods, and all openings of the tank car, record a change in a number of goods during loading and unloading in real time, and perform regular or irregular inventory on a number of carried goods. On this basis, the system can comprehensively determine whether the vehicle loaded with goods and the goods on the vehicle are at risk of being stolen and robbed or lost. When a detection result or an intelligent analysis result of the monitored object triggers a theft warning or alarm, warning or alarm information is sent to the remote management unit through the network communication module of the on-board gateway unit, and a corresponding local warning acousto-optic or voice prompt is sent through the alarm prompt unit to prompt the driver to stop for inspection or prepare for security.

### BRIEF DESCRIPTION OF THE DRAWINGS

The present invention is further described below with reference to the accompanying drawings and specific implementations.

FIG. 1 is a schematic diagram of an overall composition principle of a safety protection system for a freight automobile and on-board goods in an example of the present invention;

FIG. 2 is a schematic diagram of a composition principle and use flow of an anti-theft and anti-robbery monitoring and warning unit in an example of the present invention;

FIG. 3 is a schematic diagram of a composition of an automobile anti-theft alarm module of an anti-theft and anti-robbery monitoring and warning unit in an example of the present invention;

FIG. 4 is a schematic diagram of a composition of an automobile anti-robbery monitoring module of an anti-theft and anti-robbery monitoring and warning unit in an example of the present invention;

FIG. 5 is a schematic diagram of a composition of an automobile anti-theft and anti-robbery positioning and tracking module of an anti-theft and anti-robbery monitoring and warning unit in an example of the present invention;

FIG. 6 is a schematic diagram of a composition of a vehicle fuel tank safety monitoring module of an anti-theft and anti-robbery monitoring and warning unit in an example of the present invention;

FIG. 7 is a schematic diagram of a composition of an access intrusion detection module of an anti-theft and anti-robbery monitoring and warning unit in an example of the present invention;

FIG. 8 is a schematic diagram of a composition of a goods anti-theft video monitoring module of an anti-theft and anti-robbery monitoring and warning unit in an example of the present invention;

FIG. 9 is a schematic diagram of a composition of an automatic goods inventory module of an anti-theft and anti-robbery monitoring and warning unit in an example of the present invention;

FIG. 10 is a schematic diagram of a composition principle of an on-board gateway unit and a network communication module thereof in an example of the present invention;

FIG. 11 is a schematic diagram of a composition principle and use flow of an alarm prompt unit in an example of the present invention;

FIG. 12 is a schematic diagram of a composition principle and use flow of a remote management unit in an example of the present invention;

FIG. 13 is a schematic diagram of a composition principle of a government industry management client in an example of the present invention;

FIG. 14 is a schematic diagram of a composition principle of an enterprise operation management client in an example of the present invention;

FIG. 15 is a schematic diagram of a composition principle of a driver and passenger service client in an example of the present invention; and

FIG. 16 is a schematic diagram of a composition of a communication center in an example of the present invention.

### DETAILED DESCRIPTION

In order to make the technical means, creation features, purpose and efficacy realized by the present invention easy to understand, the present invention is further described with reference to specific drawings.

In view of the problem that the existing freight automobiles cannot monitor on-board goods in real time, and great safety risks exist, it is necessary to perform comprehensive and effective safety monitoring on the freight automobiles and on-board goods thereof during transport. Therefore, this example provides a safety protection system that can comprehensively monitor a freight automobile and on-board goods thereof.

The safety protection system for a freight automobile and on-board goods provided in this example can monitor, by organically integrating application of Internet of Things, cloud computing, machine vision, and the artificial intelligence AI technology, conditions such as the illegal position movement or an abnormal start when the vehicle stops, the armed person around the vehicle, and gathering of abnormal persons, can locate and track a real-time position of the vehicle after an anti-theft and anti-robbery alarm is triggered, perform real-time video monitoring on a position of the fuel tank of the freight vehicle loaded with on-board goods, a goods condition inside a closed van loaded with goods, and all openings of the tank car, record a change in a number of goods during loading and unloading in real time, and perform regular or irregular inventory on a number of carried goods. According to the technical solution of comprehensively determining whether the vehicle and the goods on the vehicle are at risk of being stolen and robbed or lost, when the detection result or intelligent analysis result of the monitored object triggers the theft warning or alarm of the on-board goods, the warning or alarm information is sent to the remote management unit through the network communication module of the on-board gateway unit, and a corresponding local warning acousto-optic or voice prompt is sent through the alarm prompt unit to prompt the driver to stop for inspection or prepare for security.

It should be noted herein that the freight automobiles targeted by the present invention cover all freight vehicles, such as green pass vehicles, ordinary freight vehicles, express logistics vehicles, and train freight vehicles.

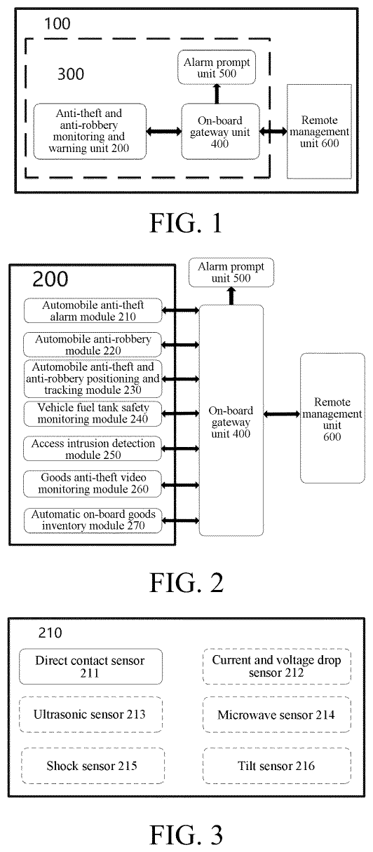

Referring to FIG. 1, FIG. 1 is a schematic diagram of the overall composition principle of a safety protection system for a freight automobile and on-board goods provided in this example.

As shown in FIG. 1, the safety protection system 100 for a freight automobile and on-board goods provided in this example is mainly composed of an anti-theft and anti-robbery monitoring and warning unit 200, an on-board gateway unit 400, an alarm prompt unit 500, a remote management unit 600, which are in cooperation with each other.

As shown in FIG. 1, the anti-theft and anti-robbery monitoring and warning unit 200 in the system is arranged in a cab of a freight automobile 300, inside the vehicle, outside the vehicle, inside a compartment, at a door of the compartment, at an opening of an oil tank of the vehicle, and at an inlet and outlet pipeline/oil drain valve of a tank car oil pump, is associated with the on-board gateway unit 400, and is also associated with the alarm prompt unit 500 and the remote management unit 600 through the on-board gateway unit 400.

The present anti-theft and anti-robbery monitoring and warning unit 200 can monitor conditions such as the illegal position movement or an abnormal start when the vehicle stops, the armed person around the vehicle, and gathering of abnormal persons, locate and track a real-time position of the vehicle after an anti-theft and anti-robbery alarm is triggered, perform real-time video monitoring on a position of the fuel tank of the freight vehicle loaded with goods, a goods condition inside a closed van loaded with goods, and all openings of the tank car, record a change in a number of goods during loading and unloading in real time, and perform regular or irregular inventory on a number of carried goods.

On this basis, the anti-theft and anti-robbery monitoring and warning unit 200 can further store the acquired monitoring and video monitoring information in a data storage module of the on-board gateway unit, and perform intelligent analysis on the acquired monitoring and supervision results through the device or an edge computing module of the on-board gateway unit, so as to comprehensively determine whether the vehicle loaded with goods and the goods on the vehicle are at risk of being stolen or lost. When a detection result or an intelligent analysis result of the monitored object triggers a theft warning or alarm, warning or alarm information is sent to the remote management unit through the network communication module of the on-board gateway unit, and a corresponding local warning acousto-optic or voice prompt is sent through the alarm prompt unit to prompt the driver to stop for inspection or prepare for security.

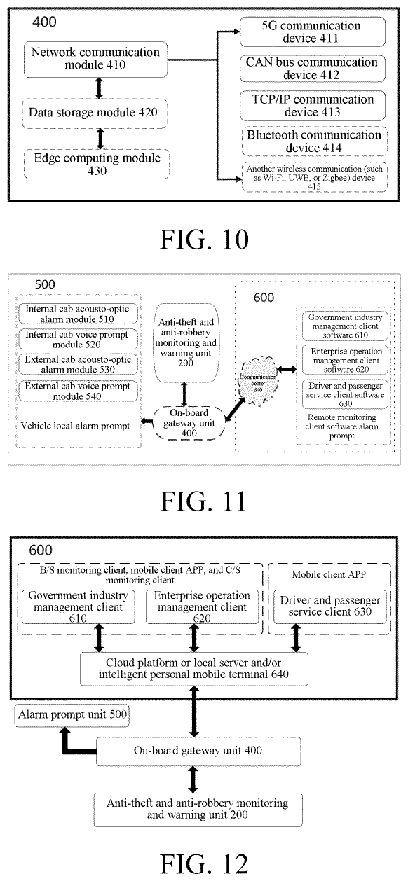

For the convenience of description, the following basic composition scheme of the on-board gateway unit 400 in this example scheme is described herein. Referring to FIG. 10, FIG. 10 is a schematic diagram of the composition principle of an on-board gateway unit and a network communication module thereof in an example of the present invention. As shown in FIG. 10, the on-board gateway unit 400 of the safety protection system 100 for a freight automobile and on-board goods provided in this example is mainly composed of a network communication module 410, a data storage module 420, and an edge computing module 430, which are in cooperation with each other.

FIG. 2 is a schematic diagram of a specific composition principle and use flow of the anti-theft and anti-robbery monitoring and warning unit 200 of a safety protection system for a freight automobile and on-board goods provided in this example.

As shown in FIG. 2, the anti-theft and anti-robbery monitoring and warning unit 200 provided in this example is mainly composed of an automobile anti-theft alarm module 210, an automobile anti-robbery monitoring module 220, an automobile anti-theft and anti-robbery positioning and tracking module 230, a vehicle fuel tank safety monitoring module 240, an access intrusion detection module 250, a goods anti-theft video monitoring module 260, and/or an automatic goods inventory module 270, which are in cooperation with each other.

The automobile anti-theft alarm module 210 is configured to monitor an illegal position movement or an abnormal start of the vehicle in a parked state, and transmit the monitoring information to a data storage module and an edge computing module of an on-board gateway unit or to a remote management unit through a network communication module of the on-board gateway unit.

The automobile anti-robbery monitoring module 220 is configured to monitor conditions such as an armed person around the vehicle and gathering of abnormal persons, and transmit the monitoring information to the data storage module and the edge computing module of the on-board gateway unit or to the remote management unit through the network communication module of the on-board gateway unit.

The automobile anti-theft and anti-robbery positioning and tracking module 230 is configured to position and track a real-time position of the vehicle after an anti-theft and anti-robbery alarm is triggered, and transmit the tracked positioning information to the remote management unit through the network communication module of the on-board gateway unit.

The vehicle fuel tank safety monitoring module 240 is configured to perform real-time video monitoring on a position of a fuel tank of the freight vehicle loaded with goods, and transmit the monitoring information to the data storage module and the edge computing module of the on-board gateway unit or to the remote management unit through the network communication module of the on-board gateway unit.

The access intrusion detection module 250 is configured to monitor a compartment door of the freight vehicle loaded with goods or an oil pump inlet and outlet pipeline/oil drain valve of a tank car, and transmit monitoring information to the data storage module and the edge computing module of the on-board gateway unit or to the remote management unit through the network communication module of the on-board gateway unit.

The goods anti-theft video monitoring module 260 is configured to perform video monitoring on a goods condition inside a closed van loaded with goods and all openings of the tank car, and transmit monitoring information to the data storage module and the edge computing module of the on-board gateway unit or to the remote management unit through the network communication module of the on-board gateway unit.

The automatic goods inventory module 270 is configured to record a change in a number of goods during loading and unloading in real time, perform regular or irregular inventory on a number of carried goods, and transmit recording and inventory information to the data storage module and the edge computing module of the on-board gateway unit or to the remote management unit through the network communication module of the on-board gateway unit.

Further, as shown in FIG. 1, FIG. 2, and FIG. 10, the anti-theft and anti-robbery monitoring and warning unit 200 arranged in this way can monitor, through the automobile anti-theft alarm module 210, conditions such as the illegal position movement or an abnormal start in a parked state of the vehicle, monitor, through the automobile anti-robbery monitoring module 220, an armed person around the vehicle and gathering of abnormal persons, locate and track the real-time position of the vehicle through the automobile anti-theft and anti-robbery positioning and tracking module 230 after an anti-theft and anti-robbery alarm is triggered, perform real-time video monitoring on a position such as a compartment door of the freight vehicle loaded with goods or an oil pump inlet and outlet pipeline/oil drain valve of the tank car through the vehicle fuel tank safety monitoring module 240, monitor a compartment access of the freight vehicle loaded with goods or the oil pump inlet and outlet pipeline/oil drain valve of the tank car through the access intrusion detection module 250, perform video monitoring on a goods condition inside a closed van loaded with goods and all openings of the tank car through the goods anti-theft video monitoring module 260, record a change in a number of goods during loading and unloading in real time through the automatic goods inventory module 270, and perform regular or irregular inventory on a number of carried goods.

Meanwhile, the present anti-theft and anti-robbery monitoring and warning unit 200 can further upload the monitoring information and inventory results to the data storage module 420 of the on-board gateway unit 400 through the network communication module 410 of the on-board gateway unit 400, and perform intelligent analysis through the edge computing module 430 of the on-board gateway unit 400. When the detection result or intelligent analysis result of the monitored object triggers a warning or an alarm, warning information is sent out, and when the warning is triggered, a local warning acousto-optic or voice prompt is sent through the alarm prompt unit 500 while the warning information is sent to the remote management unit 600 through the network communication module 410 of the on-board gateway unit 400.

As shown in FIG. 1, the on-board gateway unit 400 in the system is arranged in the cab of the freight automobile 300, and is respectively associated with the anti-theft and anti-robbery monitoring and warning unit 200, the alarm prompt unit 500, and the remote management unit 600.

The present on-board gateway unit 400 has at least a network communication function, a data storage function, and an edge computing function. The present on-board gateway unit 400 can establish a communication channel with the remote management unit 600 to analyze sensing and monitoring data information generated by the anti-theft and anti-robbery monitoring and warning unit 200. When the analysis results trigger an alarm, alarm information is sent to the remote management unit 600 and the alarm prompt unit 500 respectively, and a management command such as threshold setting adjustment of the remote management unit 600 is sent to the anti-theft and anti-robbery monitoring and warning unit 200.

Referring to FIG. 10, FIG. 10 is a schematic diagram of a composition principle of an on-board gateway unit 400 of a safety protection system for a freight automobile and on-board goods and a network communication module thereof provided in this example.

As shown in FIG. 10, the on-board gateway unit 400 provided in this example is composed of a network communication module 410, a data storage module 420, and an edge computing module 430 in combination with each other.

The network communication module 410 herein is configured for data exchange between the anti-theft and anti-robbery monitoring and warning unit 200 and the alarm prompt unit 500 and the remote management unit 600, and is configured to forward the monitoring information uploaded by the anti-theft and anti-robbery monitoring and warning unit 200 and the analysis result to the remote management unit 600, or based on the received command of the remote management unit, forward an alarm command and voice prompt command information to the alarm prompt unit 500, and forward command information such as alarm threshold setting adjustment and circuit control to the relevant monitoring device of the anti-theft and anti-robbery monitoring and warning unit 200.

The data storage module 420 is configured to store the monitoring information uploaded by the anti-theft and anti-robbery monitoring and warning unit 200.

The edge computing module 430 herein is configured to perform intelligent analysis and determination based on the monitoring information uploaded by the anti-theft and anti-robbery monitoring and warning unit 200.

As shown in FIG. 1 and FIG. 10, the on-board gateway unit 400 arranged in this way performs communication connection and data exchange with various devices installed in the anti-theft and anti-robbery monitoring and warning unit 200 through the network communication module 410, realizes information interaction with the alarm prompt unit 500 and the remote management unit 600, aggregates and stores various sensor monitoring data through the data storage module 420, and performs intelligent analysis on the various monitoring data through the edge computing module 430.

When the on-board gateway unit 400 receives the monitoring information of the anti-theft and anti-robbery monitoring and warning unit 200 and analyzes and determines that a relevant warning and alarm indicating that goods are stolen and robbed is triggered, the on-board gateway unit 400 sends an acousto-optic alarm or voice prompt information to the alarm prompt unit 500 and sends the warning and alarm information and real-time monitoring information to the remote management unit 600. When receiving an alarm command, a voice prompt command, or an alarm threshold setting adjustment sent by the remote management unit 600, the on-board gateway unit 400 sends the alarm command and the voice prompt command information to the alarm prompt unit 500, sends command information such as the alarm threshold setting adjustment and circuit control to a relevant monitoring device of the anti-theft and anti-robbery monitoring and warning unit 200 to perform relevant operations such as adjusting an alarm threshold of a monitoring sensor and starting the positioning and tracking device or a related pinhole camera.

As shown in FIG. 1, the alarm prompt unit 500 in the system has a vehicle local alarm prompt subunit and a remote monitoring client software alarm prompt subunit. The vehicle local alarm prompt subunit (such as a local acousto-optic alarm or voice prompt device) is arranged in the cab of the freight automobile 300 and outside the vehicle, and is connected to the on-board gateway unit 400, and the remote monitoring client software alarm prompt subunit of the alarm prompt unit is arranged in a government industry management client software, an enterprise operation management client software, and a driver and passenger service client software of the remote management unit 600, and is connected to the on-board gateway unit 400.

The vehicle local alarm prompt subunit in the present alarm prompt unit 500 can send a voice prompt or acousto-optic alarm based on the monitoring analysis result sent by the on-board gateway unit. The remote monitoring client software alarm prompt subunit in the present alarm prompt unit 500 can send a voice or text prompt based on the monitoring analysis result sent by the on-board gateway unit 400.

FIG. 11 is a schematic diagram of a composition principle and use flow of an alarm prompt unit 500 of a safety protection system for a freight automobile and on-board goods provided in this example.

As shown in FIG. 11, the alarm prompt unit 500 provided in this example is composed of vehicle local alarm prompt subunits such as an internal cab acousto-optic alarm module 510, an internal cab voice prompt module 520, an external cab acousto-optic alarm module 530, and an external cab voice prompt module 540, and remote monitoring client software alarm prompt subunits such as a government industry management client software 610, an enterprise operation management client software 620, and a driver and passenger service client software 630, which are in cooperation with each other.

The internal cab acousto-optic alarm module 510 is configured to send an acousto-optic alarm when receiving on-board goods anti-theft and anti-robbery monitoring and warning information. As an example, light emitted by the acousto-optic alarm of the acousto-optic alarm module is generally red by default.

The internal cab voice prompt module 520 is configured to send a voice prompt when receiving on-board goods anti-theft and anti-robbery monitoring and warning information, to prompt the driver to stop nearby or stop immediately for inspection. As an example, the internal cab voice prompt module may be arranged independently from the internal cab acousto-optic alarm module or combined into a voice acousto-optic alarm.

The external cab acousto-optic alarm module 530 is configured to send an acousto-optic alarm when receiving high-risk-level on-board goods anti-theft and anti-robbery monitoring and warning information. As an example, light emitted by the acousto-optic alarm of the acousto-optic alarm module is generally red by default, and the alarm sound is loud enough to alert passers-by in the noisy environment on the road.

The external cab voice prompt module 540 is configured to send a voice prompt when receiving the high-risk-level on-board goods anti-theft and anti-robbery monitoring and warning information, so as to prompt other persons on the road to avoid or warn robbers to stop committing crimes as soon as possible. As an example, the voice broadcast of the voice warning content is clear enough to be clearly understood by listeners.

The government industry management client software 610 is configured to receive alarm information forwarded by the on-board gateway unit 400 through the communication center when the high-risk-level on-board goods anti-theft and anti-robbery monitoring and warning information occurs. As an example, the government industry management client software starts an emergency management process according to the emergency plan by default when receiving the high-risk-level on-board goods anti-theft and anti-robbery monitoring and warning information.

The enterprise operation management client software 620 is configured to receive alarm information forwarded by the on-board gateway unit 400 through the communication center when the on-board goods anti-theft and anti-robbery monitoring and warning information occurs. As an example, the enterprise operation management client software starts an emergency management process according to the emergency plan by default and synchronously sends emergency alarm information to the government industry management client when the high-risk-level on-board goods anti-theft and anti-robbery monitoring and warning information occurs.

The driver and passenger service client software 630 is configured to receive alarm information forwarded by the on-board gateway unit 400 through the communication center when the on-board goods anti-theft and anti-robbery monitoring and warning information occurs. As an example, the driver and passenger service client sends a voice prompt while sending alarm information.

As shown in FIG. 1 and FIG. 11, the alarm prompt unit 500 arranged in this way may be configured to: send an acousto-optic alarm through the internal cab acousto-optic alarm module 510 when receiving on-board goods anti-theft and anti-robbery monitoring and warning information sent by the anti-theft and anti-robbery monitoring and warning unit 200; send a voice prompt through the internal cab voice prompt module 520 when receiving the on-board goods anti-theft and anti-robbery monitoring and warning information sent by the anti-theft and anti-robbery monitoring and warning unit 200, to prompt the driver to stop nearby or stop immediately for inspection;
send an acousto-optic alarm through the external cab acousto-optic alarm module 530 when receiving the on-board goods anti-theft and anti-robbery monitoring and warning information sent by the anti-theft and anti-robbery monitoring and warning unit 200; and send a voice prompt through the external cab voice prompt module 540 when receiving the on-board goods anti-theft and anti-robbery monitoring and warning information sent by the anti-theft and anti-robbery monitoring and warning unit 200, so as to prompt other persons on the road to avoid or warn robbers to stop committing crimes.

The alarm prompt unit 500 arranged in this way may further be configured to: receive, through the government industry management client software 610, the alarm information forwarded by the on-board gateway unit 400 through the communication center when the high-risk-level on-board goods anti-theft and anti-robbery monitoring and warning information occurs; and
receive, through the enterprise operation management client software 620, the alarm information forwarded by the on-board gateway unit 400 through the communication center when automobile or on-board goods anti-theft and anti-robbery monitoring and warning information occurs. The enterprise operation management client software is configured to: start an emergency management process according to the emergency plan by default and synchronously send emergency alarm information to the government industry management client 610 when receiving the high-risk-level automobile or on-board goods anti-theft and anti-robbery monitoring and warning information; and
receive, through the driver and passenger service client software 630, the alarm information forwarded by the on-board gateway unit 400 through the communication center when the automobile or on-board goods anti-theft and anti-robbery monitoring and warning information occurs. The driver and passenger service client sends a voice prompt while sending alarm information.

As shown in FIG. 1, the remote management unit 600 in the system is arranged on a cloud platform of a competent government department related to automobile transportation and/or a local storage server and/or a personal hand-held intelligent terminal of a relevant management person, a cloud platform of a transportation enterprise to which the automobile belongs and a transportation-related party and/or a local storage server and/or a personal hand-held intelligent terminal of a relevant management person, and a personal hand-held intelligent terminal of a driver and passenger, is directly associated with the on-board gateway unit 400 of the vehicle, and is indirectly associated with the anti-theft and anti-robbery monitoring and warning unit 200 and the alarm prompt unit 500 through the on-board gateway unit 400.

The remote management unit 600 may send a command to set and adjust the alarm threshold of a relevant sensor of the anti-theft and anti-robbery monitoring and warning unit 200, and receive the on-board goods anti-theft and anti-robbery monitoring and warning information sent by the on-board gateway unit 400.

Referring to FIG. 12, FIG. 12 is a schematic diagram of a composition principle and use flow of a remote management unit 600 of a safety protection system for a freight automobile and on-board goods provided in this example.

As shown in FIG. 12, the remote management unit 600 provided in this example is composed of a government industry management client software 610, an enterprise operation management client software 620, a driver and passenger service client software 630, and a communication center (a cloud platform or a local server and/or a personal mobile intelligent terminal) 640, which are in cooperation with each other.

The government industry management client software 610 in the present remote management unit 600 is configured to: receive and display high-risk-level on-board goods anti-theft and anti-robbery monitoring and warning information forwarded by the anti-theft and anti-robbery monitoring and warning unit 200 through the on-board gateway unit 400 and the communication center, send a relevant management command based on the received warning and alarm information, start an emergency management process, and issue a relevant emergency response command.

The enterprise operation management client software 620 in the present remote management unit 600 is configured to: receive and display automobile or on-board goods anti-theft and anti-robbery monitoring and warning information forwarded by the anti-theft and anti-robbery monitoring and warning unit 200 through the on-board gateway unit 400 and the communication center, send a relevant management command based on the received warning and alarm information, and start an emergency management process, give an emergency alarm, and issue a relevant emergency response command to the government industry management client when receiving the high-risk-level on-board goods anti-theft and anti-robbery monitoring and warning information.

The driver and passenger service client software 630 in the present remote management unit 600 is configured to: receive and display automobile or on-board goods anti-theft and anti-robbery monitoring and warning information forwarded by the anti-theft and anti-robbery monitoring and warning unit 200 through the on-board gateway unit 400 and the communication center, and send an acousto-optic alarm and a voice prompt based on the received alarm and warning information, to prompt the driver to check the vehicle immediately or stop nearby for inspection immediately.

The communication center 640 in the present remote management unit 600 is configured to communicate with the on-board gateway unit 400, receive and store the on-board goods anti-theft and anti-robbery monitoring and warning information forwarded by the anti-theft and anti-robbery monitoring and warning unit 200 through the on-board gateway unit 400, and forward the on-board goods anti-theft and anti-robbery monitoring and warning information to the government industry management client software 610, the enterprise operation management client software 620, and the driver and passenger service client software 630 respectively. The communication center also serves as a computer system environment for government industry management client software, the enterprise operation management client software, and the driver and passenger service client software, supports related software applications, and forwards management commands or reply commands of the government industry management client software, the enterprise operation management client software, and the driver and passenger service client software to the on-board gateway unit.

As shown in FIG. 1 and FIG. 12, the remote management unit 600 arranged in this way is configured to: receive and display, through the government industry management client software 610, high-risk-level automobile or on-board goods anti-theft and anti-robbery monitoring and warning information forwarded by the anti-theft and anti-robbery monitoring and warning unit 200 through the on-board gateway unit 400 and the communication center 640, send a relevant management command based on the received warning and alarm information, start an emergency management process, and issue a relevant emergency response command;
receive and display, through the enterprise operation management client software 620, automobile or on-board goods anti-theft and anti-robbery monitoring and warning information forwarded by the anti-theft and anti-robbery monitoring and warning unit 200 through the on-board gateway unit 400 and the communication center 640, send a relevant management command based on the received warning and alarm information, and start an emergency management process, give an emergency alarm, and issue a relevant emergency response command to the government industry management client 610 when receiving the high-risk-level automobile or on-board goods anti-theft and anti-robbery monitoring and warning information; and
receive and display, through the driver and passenger service client software 630, automobile or on-board goods anti-theft and anti-robbery monitoring and warning information forwarded by the anti-theft and anti-robbery monitoring and warning unit 200 through the on-board gateway unit 400 and the communication center 640, and send an acousto-optic alarm and a voice prompt based on the received alarm and warning information.

The remote management unit can communicate with the on-board gateway unit 400 through the communication center 640, receive and store the on-board goods anti-theft and anti-robbery monitoring and warning information forwarded by the anti-theft and anti-robbery monitoring and warning unit 200 through the on-board gateway unit 400, and forward the on-board goods anti-theft and anti-robbery monitoring and warning information to the government industry management client software 610, the enterprise operation management client software 620, and the driver and passenger service client software 630 respectively. The communication center 640 also serves as a computer system environment for government industry management client software 610, the enterprise operation management client software 620, and the driver and passenger service client software 630, supports related software applications, and forwards management commands or reply commands of the government industry management client software 610, the enterprise operation management client software 620, and the driver and passenger service client software 630 to the on-board gateway unit 400.

The safety protection system 100 for a freight automobile and on-board goods accordingly formed can monitor, through the automobile anti-theft alarm module of the anti-theft and anti-robbery monitoring and warning unit 200, conditions such as the illegal position movement or an abnormal start in a parked state of the vehicle, monitor, through the automobile anti-robbery monitoring module of the anti-theft and anti-robbery monitoring and warning unit 200, conditions such as an armed person around the vehicle and gathering of abnormal persons, locate and track the real-time position of the vehicle through the automobile anti-theft and anti-robbery positioning and tracking module of the anti-theft and anti-robbery monitoring and warning unit 200 after an anti-theft and anti-robbery alarm is triggered, perform real-time video monitoring on a position such as a compartment door of the freight vehicle loaded with goods or an oil pump inlet and outlet pipeline/oil drain valve of the tank car through the vehicle outside video monitoring module of the anti-theft and anti-robbery monitoring and warning unit 200, monitor a compartment access of the freight vehicle loaded with goods or the oil pump inlet and outlet pipeline/oil drain valve of the tank car through the access intrusion detection module of the anti-theft and anti-robbery monitoring and warning unit 200, perform video monitoring on a goods condition inside a closed van loaded with goods and all openings of the tank car through the goods anti-theft video monitoring module of the anti-theft and anti-robbery monitoring and warning unit 200, record a change in a number of goods during loading and unloading in real time through the automatic goods inventory module of the anti-theft and anti-robbery monitoring and warning unit 200, perform regular or irregular inventory on a number of carried goods, and when the detection result or intelligent analysis result of the monitored object triggers a warning or an alarm, send warning information.

The on-board gateway unit 400 in the system performs communication connection and data exchange with various devices installed in the anti-theft and anti-robbery monitoring and warning unit 200 through the network communication module, realizes information interaction with the alarm prompt unit 500 and the remote management unit 600, aggregates and stores various sensor monitoring data through the data storage module, and performs intelligent analysis on the various monitoring data through the edge computing module. When the smart analysis results of various monitoring data trigger a warning or an alarm, the on-board gateway unit 400 sends the warning or alarm information to the alarm prompt unit 500 and the remote management unit 600 respectively through the network communication module, and the alarm prompt unit 500 sends an acousto-optic alarm or voice prompt in the local cab or outside the cab through the acousto-optic alarm module and/or voice prompt module in the cab, the acousto-optic alarm module and/or voice prompt module outside the cab and/or the remote alarm prompt module. The remote management unit 600 may respectively display alarm prompt results or set relevant sensor warning and alarm thresholds through the government industry management client, the enterprise operation management client, and the driver and passenger service client, so as to automatically monitor automobile and on-board goods anti-theft and anti-robbery safety information during the transport. When there is a risk of theft or robbery of the on-board goods, an acousto-optic warning and alarm or voice prompts are provided to the driver and passenger to prompt the driver and passenger to get off the vehicle in time for inspection and processing or to prepare for security. In addition, the on-board goods safety monitoring warning and alarm information is uploaded to an enterprise and a competent industry department to which the vehicle belongs, the emergency response voice prompt or file push guide is played on the spot, and emergency rescue is quickly enabled, which is of great significance to improving monitoring, warning, and prevention capabilities of goods transportation safety accidents, and improving efficiency of emergency response to goods transportation safety accidents and the anti-terrorism prevention capability of goods transport.

On this basis, this example further clearly provides specific devices that may be involved in each unit module of the safety protection system for a freight automobile and on-board goods, and describes a feasible deployment scheme of the corresponding unit module by using examples.

With reference to FIG. 2 and FIG. 3, this example provides a schematic diagram of a composition of an automobile anti-theft alarm module 210 in an anti-theft and anti-robbery monitoring and warning unit.

Based on FIG. 3, the automobile anti-theft alarm module 210 in the anti-theft and anti-robbery monitoring and warning unit 200 provided in this example is composed of a direct contact sensor 211 and/or a current and voltage drop sensor 212 and/or an ultrasonic sensor 213 and/or a microwave sensor 214 and/or a shock sensor 215 and/or a tilt sensor 216. The direct contact sensor 211 is configured to trigger an alarm when a door, a trunk, a rear hatch, or the like is forced open.

The current and voltage drop sensor 212 is configured to monitor a change in a vehicle circuit system, and trigger an alarm, for example, when the vehicle circuit system changes.

The ultrasonic sensor 213 is configured to monitor a change in air pressure in a vehicle cab and trigger an alarm, for example, when a window is broken or someone enters the vehicle cab when the vehicle is parked.

The microwave sensor 214 is configured to monitor solid objects passing through light beams emitted from all entry points in the vehicle cab, and trigger an alarm, for example, when someone enters the vehicle cab when the vehicle is parked.

The shock sensor 215 is configured to monitor a sudden shock of the vehicle, and trigger an alarm, for example, when someone tries to smash glass and enter the vehicle cab or destroy the vehicle.

The tilt sensor 216 is configured to monitor a sudden tilt of the vehicle, and trigger an alarm, for example, when someone tries to tow the vehicle away.

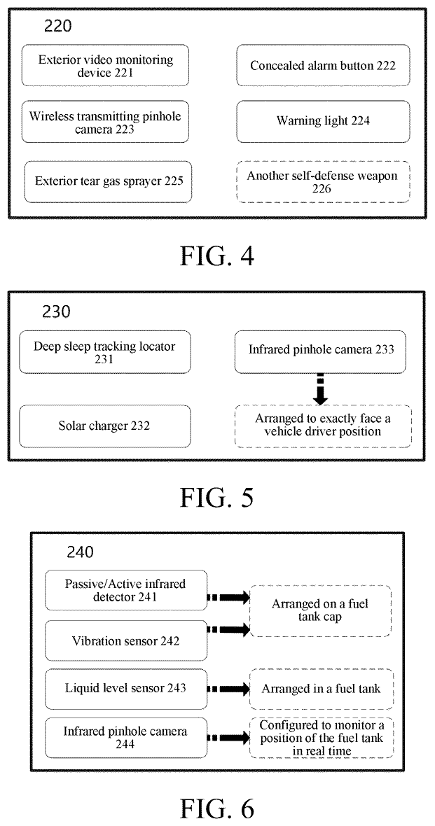

With reference to FIG. 2 and FIG. 4, this example provides a schematic scheme of a composition of an automobile anti-robbery monitoring module 220 in the anti-theft and anti-robbery monitoring and warning unit of the safety protection system for a freight automobile and on-board goods.

As shown in FIG. 4, the automobile anti-robbery monitoring module 220 of the anti-theft and anti-robbery monitoring and warning unit 200 provided in this example is composed of an exterior video monitoring device 221, a concealed alarm button 222, a wireless transmitting pinhole camera 223, a warning light 224, an exterior tear gas sprayer 225, and another self-defense weapon 226 together.

The exterior video monitoring device 221 is configured to acquire an image of a person around the vehicle, and trigger an alarm when a plurality of persons approach with weapons or abnormal persons gather.

The concealed alarm button 222 is configured to send a robbery emergency alarm when a driver has confirmed that a robbery event occurs.

The wireless transmitting pinhole camera 223 is configured to acquire behavior images of robbers outside the vehicle when the robbery emergency alarm is triggered.

The exterior tear gas sprayer 224 is configured to automatically release commonly used tear sprays such as o-chlorobenzylidene malononitrile (CS) and/or chloroacetophenone (CN) and/or capsaicine (OC) when the robbery emergency alarm is triggered.

The warning light 225 is configured to continuously flash on a roof of the vehicle when an emergency alarm is triggered, so as to deter the gangsters at the robbery site and guide vehicle positions for policemen who are rushing to the robbery site.

The another self-defense weapon 226 includes, but is not limited to a strong flashlight, an expandable baton, a flash bomb, or a small dry powder fire extinguisher, and is configured to trigger the driver and passenger to delay the robbery action of the gangster during the robbery emergency alarm, which improves a sense of security and self-defense ability of the driver and passenger.

With reference to FIG. 2 and FIG. 5, this example provides a specific schematic composition scheme of an automobile anti-theft and anti-robbery positioning and tracking module 230 in the anti-theft and anti-robbery monitoring and warning unit of the safety protection system for a freight automobile and on-board goods.

As shown in FIG. 5, the automobile anti-theft and anti-robbery positioning and tracking module 230 in the anti-theft and anti-robbery monitoring and warning unit 200 provided in this example is composed of a deep sleep tracking locator 231, a solar charger 232, and an infrared pinhole camera 233 at an automobile driver position.

The deep sleep tracking locator 231 is configured to start real-time positioning after the vehicle is stolen and robbed and a satellite positioning system of an on-board terminal unit is destroyed or powered off. As an example, the tracking locator herein includes but is not limited to Beidou satellite positioning and/or GPS positioning and/or GLONASS positioning and/or GSNS satellite positioning.

The solar charger 232 is configured to charge the deep sleep tracking locator to ensure that the deep sleep tracking locator is in an operating state after being started. The infrared pinhole camera 233 at the automobile driver position is configured to acquire an image of a person at the automobile driver position in real time after the deep sleep tracking locator is started.

With reference to FIG. 2 and FIG. 6, this example provides a specific schematic composition scheme of a vehicle fuel tank safety monitoring module 240 in the anti-theft and anti-robbery monitoring and warning unit of the safety protection system for a freight automobile and on-board goods.

As shown in FIG. 6, the vehicle fuel tank safety monitoring module 240 in the anti-theft and anti-robbery monitoring and warning unit 200 provided in this example is composed of an infrared detector 241 and a vibration sensor 242 arranged on a fuel tank cap, a liquid level sensor 243 arranged in a fuel tank, and/or an infrared pinhole camera 244 configured to monitor a position of the fuel tank in real time.

The infrared detector 241 is configured to detect a person approaching the oil tank in an armed state without needing to refuel the oil tank, and trigger an alarm when a person enters a detection area in the armed state.

The vibration sensor 242 is configured to detect abnormal vibration of the fuel tank cap in the armed state without needing to refuel the fuel tank, and trigger an alarm when the fuel tank cap vibrates in the armed state.

The liquid level sensor 243 in the fuel tank is configured to detect an abnormal drop of a gasoline or diesel liquid level in the fuel tank, and trigger an alarm when the oil level drops rapidly in the armed state.

The infrared pinhole camera 244 that can monitor the position of the fuel tank in real time is configured to acquire an image of a person approaching the fuel tank in the armed state without needing to refuel the fuel tank, and start the camera when a vehicle fuel tank safety monitoring alarm is triggered.

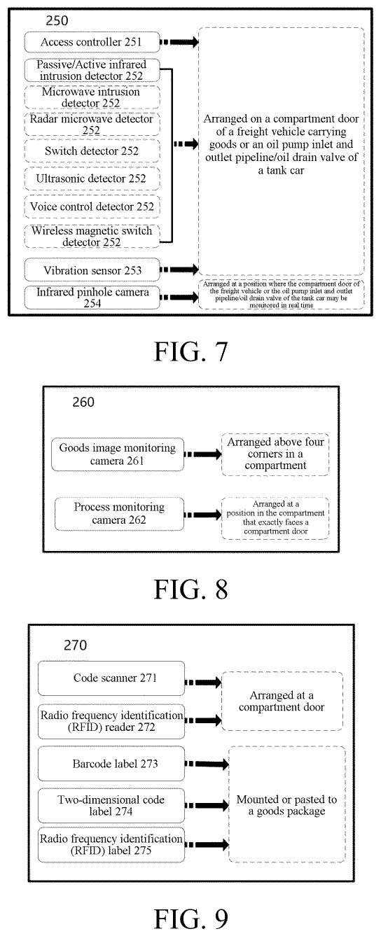

With reference to FIG. 2 and FIG. 7, this example provides a specific schematic composition scheme of an access intrusion detection module 250 in the anti-theft and anti-robbery monitoring and warning unit of the safety protection system for a freight automobile and on-board goods.

As shown in FIG. 7, the access intrusion detection module 250 of the anti-theft and anti-robbery monitoring and warning unit 200 provided in this example is composed of an access controller 251, a passive infrared intrusion detector 252 (in addition, an active infrared intrusion detector or a microwave intrusion detector or a radar microwave detector or a switch detector or an ultrasonic detector or a voice control detector or a wireless magnetic switch detector may further be selected for use), a vibration sensor 253, and a pinhole camera 254 configured to monitor a position of a compartment door of the freight vehicle or an oil pump inlet and outlet pipeline/oil drain valve of a tank car in real time, which are arranged on the compartment door of the freight vehicle carrying goods or the oil pump inlet and outlet pipeline/oil drain valve of the tank car.

The access controller 251 is configured to control opening and closing of the compartment door of the freight vehicle carrying goods or the oil pump inlet and outlet pipeline/oil drain valve of the tank car, and trigger an alarm when abnormal opening occurs. The passive infrared intrusion detector and/or the active infrared intrusion detector and/or the microwave intrusion detector and/or the radar microwave detector and/or the switch detector and/or the ultrasonic detector and/or the voice control detector and/or the wireless magnetic switch detector 252 is configured to detect abnormal approaching of a person or abnormal opening of the compartment door, the inlet and outlet pipeline/oil drain valve in the armed state, and trigger an alarm when the abnormal approaching of the person or abnormal opening of the compartment door and the inlet and outlet pipeline/oil drain valve occurs in the armed state.

The vibration sensor 253 is configured to detect abnormal vibration of the compartment door and the inlet and outlet pipeline/oil drain valve in the armed state, and trigger an alarm when vibration of the compartment door and the inlet and outlet pipeline/oil drain valve occurs in the armed state.

The pinhole camera 254 at the position of the compartment door of the freight vehicle or the oil pump inlet and outlet pipeline/oil drain valve of the tank car is configured to acquire an image of a person approaching the compartment door and the inlet and outlet pipeline/oil discharge valve in the armed state, and start the camera when an access intrusion monitoring alarm is triggered.

The specific use of the passive infrared intrusion detector or another type of intrusion detector in this example may be determined based on the actual vehicle structural characteristics and requirements of different users, which is not limited herein.

With reference to FIG. 2 and FIG. 8, this example provides a schematic scheme of a specific composition of a goods anti-theft video monitoring module 260 in the anti-theft and anti-robbery monitoring and warning unit of the safety protection system for a freight automobile and on-board goods.

As shown in FIG. 8, the goods anti-theft video monitoring module 260 in the anti-theft and anti-robbery monitoring and warning unit 200 provided in this example is composed of the goods image monitoring camera 261 arranged above four corners in a compartment and a process monitoring camera 262 arranged in the compartment exactly facing the compartment door.

The goods image monitoring cameras 261 are arranged above the four corners of the compartment and configured to acquire real-time images after goods loading. The process monitoring camera 262 is arranged at a position in the compartment that exactly faces the compartment door and configured to acquire images during goods loading and unloading.

With reference to FIG. 2 and FIG. 9, this example provides a schematic scheme of a specific composition of an automatic goods inventory module 270 in the anti-theft and anti-robbery monitoring and warning unit of the safety protection system for a freight automobile and on-board goods.

As shown in FIG. 9, the automatic goods inventory module 270 in the anti-theft and anti-robbery monitoring and warning unit 200 provided in this example is composed of a code scanner 271 or a radio frequency identification (RFID) reader 272 arranged at the compartment door, a barcode label 273, a two-dimensional code label 274, or a radio frequency identification (RFID) label 275 installed or pasted on a goods package.

The code scanner 271 or the radio frequency identification (RFID) reader 272 is configured to read the barcode label 273, the two-dimensional code label 274, or the radio frequency identification (RFID) label 275 on the goods package.

The barcode label 273, the two-dimensional code label 274, or the radio frequency identification (RFID) label 275 is configured to be pasted on the goods package for reading and statistics during loading and unloading.

The combined configuration of the radio frequency identification (RFID) reader 272 and the radio frequency identification (RFID) label 275 may be configured for regular or irregular inventory during transport. The specific use of the code scanner or the RFID reader may be determined according to the nature of the label on the outer package of goods, which is not limited herein.

The anti-theft and anti-robbery monitoring and warning unit 200 with such a composition is preferably directly associated with the on-board gateway unit 400 during deployment, and indirectly associated with the vehicle alarm prompt unit 500 and the remote management unit 600 through the on-board gateway unit 400. In this way, various monitoring devices, detection devices, and cameras of an automobile anti-theft alarm module, an automobile anti-robbery monitoring module, an automobile anti-theft and anti-robbery positioning and tracking module, a vehicle fuel tank safety monitoring module, an access intrusion detection module, a goods anti-theft video monitoring module, and/or an automatic goods inventory module in the anti-theft and anti-robbery monitoring and warning unit aggregate the monitoring data to the data storage module of the on-board gateway unit through the network communication module of the on-board gateway unit, perform intelligent analysis through the edge computing module of the on-board gateway unit, send a corresponding acousto-optic alarm or a voice prompt to the alarm prompt unit through the network communication module of the on-board gateway unit when the corresponding anti-theft and anti-robbery warning is triggered, and the alarm prompt information is uploaded to the remote management unit through the network communication module of the on-board gateway unit.

Further referring to FIG. 10, a schematic scheme of a composition of a network communication module 410 in the on-board gateway unit of the present safety protection system for a freight automobile and on-board goods is further shown.

As shown in FIG. 10, the network communication module 410 of the on-board gateway unit 400 in this example includes, but is not limited to, a 5G communication device 411, a CAN bus communication device 412, a TCP/IP communication device 413, a Bluetooth communication device 414, another wireless communication (Wi-Fi, UWB, Zigbee, or the like) device 415, and the like.

The 5G communication device 411 is configured for communication between an on-board gateway unit and a remote management unit.

The CAN bus communication device 412 is configured for wired communication between the on-board gateway unit, the anti-theft and anti-robbery monitoring and warning unit, and the alarm prompt unit in a CAN bus mode.

The TCP/IP communication device 413 is configured for wired or wireless communication between the on-board gateway unit, the anti-theft and anti-robbery monitoring and warning unit, the alarm prompt unit, and the remote management unit in a TCP/IP mode.

The Bluetooth communication device 414 is configured for wireless communication between the on-board gateway unit, the anti-theft and anti-robbery monitoring and warning unit, and the alarm prompt unit based on the Bluetooth protocol.

The another wireless communication (Wi-Fi, UWB, Zigbee, or the like) device 415 is configured for wireless communication based on a corresponding protocol such as Wi-Fi, UWB, or Zigbee between the on-board gateway unit, the anti-theft and anti-robbery monitoring and warning unit, and the alarm prompt unit.

As shown in FIG. 1 and FIG. 10, the network communication module 410 arranged in this way may be configured to: perform the communication between the on-board gateway unit 400 and the remote management unit 600 through the 5G communication device 411;
perform wired communication between the on-board gateway unit 400, the anti-theft and anti-robbery monitoring and warning unit 200, and the alarm prompt unit 500 in a CAN bus mode through the CAN bus communication device 412;
perform wired or wireless communication between the on-board gateway unit 400, the anti-theft and anti-robbery monitoring and warning unit 200, the alarm prompt unit 500, and the remote management unit 600 in a TCP/IP mode through the TCP/IP communication device 413;
perform wireless communication between the on-board gateway unit 400, the anti-theft and anti-robbery monitoring and warning unit 200, and the alarm prompt unit 400 based on the Bluetooth protocol through the Bluetooth communication device 414; and
perform wireless communication based on a corresponding protocol such as Wi-Fi, UWB, or Zigbee between the on-board gateway unit 400, the anti-theft and anti-robbery monitoring and warning unit 200, and the alarm prompt unit 500 through the another wireless communication (Wi-Fi, UWB, Zigbee, or the like) device 415.

With reference to FIG. 10, this example further shows a schematic scheme of a composition of a data storage module 420 in the on-board gateway unit 400 of the present safety protection system for a freight automobile and on-board goods.

The data storage module 420 in this example preferably includes a built-in data storage device and an external data storage device.

The built-in data storage device herein includes but is not limited to a built-in static random access memory SRAM, a built-in dynamic random access memory DRAM, and a built-in hard disk, and the external data storage device includes but is not limited to an external mobile hard disk, a USB flash drive, a TF memory card, and an SD memory card.

In this example scheme, the built-in data storage device and the external data storage device both may be configured to store monitoring information uploaded by the anti-theft and anti-robbery monitoring and warning unit.

With reference to FIG. 10, this example further shows a schematic scheme of a composition of an edge computing module 430 in the on-board gateway unit 400 of the present safety protection system for a freight automobile and on-board goods.

Specifically, the edge computing module 430 of the present on-board gateway unit 400 includes an AI smart chip with an edge computing function and a terminal SDK with the edge computing function.

In this example scheme, a circuit board AI smart chip with an edge computing function and the terminal SDK with the edge computing function are configured to perform intelligent analysis and determination based on the monitoring information uploaded by the anti-theft and anti-robbery monitoring and warning unit.

The on-board gateway unit 400 configured in this way is preferably directly associated with the anti-theft and anti-robbery monitoring and warning unit 200, the alarm prompt unit 500, and the remote management unit 600 during deployment.

In the on-board gateway unit 400 deployed in this way, when the on-board gateway unit receives the monitoring information of the anti-theft and anti-robbery monitoring and warning unit and determines through analysis that when a related goods theft and robbery warning and alarm is triggered, the on-board gateway unit sends an acousto-optic alarm or voice prompt information to the alarm prompt unit and sends the warning and alarm information and real-time monitoring information to the remote management unit.

When receiving an alarm command, a voice prompt command, an alarm threshold setting adjustment, or emergency rescue guide information sent by the remote management unit, the on-board gateway unit sends the alarm command and the voice prompt command information to the alarm prompt unit, and sends command information such as the alarm threshold setting adjustment and circuit control to a relevant monitoring device of the anti-theft and anti-robbery monitoring and warning unit to perform a relevant operation such as adjusting an alarm threshold of a monitoring sensor and starting the positioning and tracking device or a related pinhole camera.

With reference to FIG. 1 and FIG. 11, the alarm prompt unit 500 in this example is preferably directly associated with the on-board gateway unit 400 during deployment, and indirectly associated with the anti-theft and anti-robbery monitoring and warning unit 200 and the remote management unit 600 through the on-board gateway unit 400.

During operation of the alarm prompt unit 500 deployed in this way in cooperation with another unit, when the local alarm prompt subunit receives the on-board goods anti-theft and anti-robbery monitoring and warning information with a medium risk level or a low risk level sent by the on-board gateway unit, the alarm prompt unit sends an internal cab acousto-optic alarm and sends a voice prompt to prompt the driver to stop nearby or immediately for inspection.

When the local alarm prompt subunit receives the high-risk-level on-board goods anti-theft and anti-robbery monitoring and warning information, the alarm prompt unit sends internal cab and external cab acousto-optic alarms and internal cab and external cab voice prompts to prompt the driver to stop immediately for inspection and to prompt passers-by to be alert to abnormal vehicles and avoid in time or immediately call the police or warn gangsters who are in the state of theft and robbery to stop criminal behavior.

When the remote monitoring client software alarm prompt subunit receives the on-board goods anti-theft and anti-robbery monitoring and warning information with a medium risk level or a low risk level, the alarm prompt unit sends an alarm prompt.

When the remote monitoring client software alarm prompt subunit receives the high-risk-level on-board goods anti-theft and anti-robbery monitoring and warning information, the alarm prompt unit sends an emergency alarm and voice prompt, and starts the emergency management process according to the emergency plan by default.

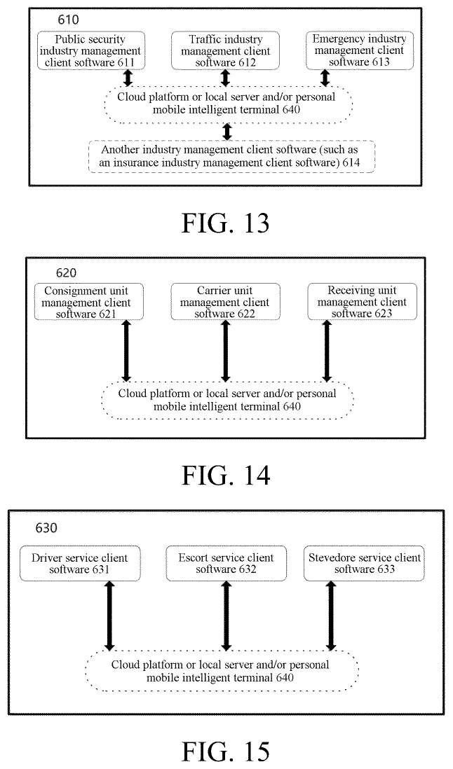

Referring to FIG. 13, FIG. 13 is a schematic diagram of a composition principle of a government industry management client 610 in a remote management unit 600 of a safety protection system for a freight automobile and on-board goods provided in this example.

As shown in FIG. 13, the government industry management client 610 of the remote management unit 600 provided in this example includes a public security industry management client software 611, a traffic industry management client software 612, an emergency industry management client software 613, another industry management client software (such as an insurance industry management client software) 614, and the like depending on different competent industry departments.

Based on FIG. 1, FIG. 12, and FIG. 13, the public security industry management client software 611 of the government industry management client 610 is configured to: receive and display high-risk-level on-board goods anti-theft and anti-robbery monitoring and warning information forwarded by the anti-theft and anti-robbery monitoring and warning unit 200 through the on-board gateway unit 400 and the communication center 640, and send, based on an information type, a traffic management command to the traffic police on duty on the road where the vehicle is located.

The traffic industry management client software 612 of the government industry management client 610 is configured to: receive and display on-board goods anti-theft and anti-robbery monitoring and warning information forwarded by the anti-theft and anti-robbery monitoring and warning unit 200 through the on-board gateway unit 400 and the communication center 640, and send, based on the information type, a management command to a relevant traffic safety responsibility unit and send another linkage management information according to the emergency plan.

The emergency industry management client software 613 of the government industry management client 610 is configured to: receive and display the high-risk-level on-board goods anti-theft and anti-robbery monitoring and warning information forwarded by the anti-theft and anti-robbery monitoring and warning unit 200 through the on-board gateway unit 400 and the communication center 640, send an emergency response command to a relevant emergency rescue person such as a firefighter based on the information type, a vehicle type, and a type of the goods loaded on a freight vehicle, and send another linkage management information according to the emergency plan setting.

The another industry management client software (such as the insurance industry management client software 614) of the government industry management client 610 is configured to receive and display on-board goods anti-theft and anti-robbery monitoring and warning information forwarded by the anti-theft and anti-robbery monitoring and warning unit 200 through the on-board gateway unit 400 and the communication center 640, and start the insurance claim service based on the information situation and send another linkage management information according to the emergency plan setting. The another industry management client software supports function customization according to the management requirements of the corresponding industry, or independently selects to enable or disable a related client monitoring function within the scope of user authority.

Referring to FIG. 14, FIG. 14 is a schematic diagram of a composition principle of an enterprise operation management client 620 of a remote management unit 600 of a safety protection system for a freight automobile and on-board goods provided in this example.

As shown in FIG. 14, the enterprise operation management client 620 of the remote management unit 600 provided in this example includes a consignment unit management client software 621, a carrier unit management client software 622, and a receiving unit management client software 623 depending on different users.

As shown in FIG. 1, FIG. 12, and FIG. 14, the consignment unit management client software 621 of the enterprise operation management client 620 is configured to receive and display safety tracking and query information of a goods consignment vehicle.

The carrier unit management client software 622 of the enterprise operation management client 620 is configured to: receive and display on-board goods anti-theft and anti-robbery monitoring and warning information forwarded by the anti-theft and anti-robbery monitoring and warning unit 200 through the on-board gateway unit 400 and the communication center 640; send emergency rescue guide information to the driver and passenger service client 630 in the form of text, image, voice, file, and the like when receiving the warning and alarm information; and when receiving a high-risk-level warning and alarm, send emergency rescue guide information to the driver and passenger service client 630 in the form of text, image, voice, file, and the like, and immediately send linkage alarm information to the government industry management client 610 according to the emergency plan setting.

The receiving unit management client software 623 of the enterprise operation management client 620 is configured to receive and display the safety tracking and query information of the goods consignment vehicle.

Referring to FIG. 15, FIG. 15 is a schematic diagram of a composition principle of a driver and passenger service client 630 of a remote management unit 600 of a safety protection system for a freight automobile and on-board goods provided in this example.

As shown in FIG. 15, the driver and passenger service client 630 of the remote management unit 600 provided in this example includes a driver service client software 631, an escort service client software 632, and a stevedore service client software 633 depending on different users.

As shown in FIG. 1, FIG. 12, and FIG. 15, the driver service client software 631 of the driver and passenger service client 630 is configured to: receive and display an electronic waybill and automobile and on-board goods anti-theft and anti-robbery monitoring and warning information forwarded by the anti-theft and anti-robbery monitoring and warning unit 200 through the on-board gateway unit 400 and the communication center 640, and receive and display emergency rescue guide information sent by the carrier management client 622 in the form of text, image, voice, file, and the like, or emergency rescue guide information automatically pushed by the driver service client software after triggering the relevant warning and alarm information. The driver service client software herein supports voice broadcast of warning information, and supports feedback of risk inspection and response results to the government industry management client and the carrier management client after the driver completes the risk check.

The escort service client software 632 of the driver and passenger service client 630 is configured to: receive and display an electronic waybill and automobile and on-board goods anti-theft and anti-robbery monitoring and warning information forwarded by the anti-theft and anti-robbery monitoring and warning unit 200 through the on-board gateway unit 400 and the communication center 640, and receive and display emergency rescue guide information sent by the carrier management client 622 in the form of text, image, voice, file, and the like, or emergency rescue guide information automatically pushed by the escort service client software after triggering the relevant warning and alarm information. The escort service client software herein supports voice broadcast of warning information, and supports feedback of risk check and response results to the government industry management client and the carrier management client by an escort after the driver completes the risk check.

The stevedore service client software 633 of the driver and passenger service client 630 is configured to receive and display an electronic waybill and a quantity change and inventory information of goods during loading and unloading uploaded by the automatic goods inventory module 270 of the anti-theft and anti-robbery monitoring and warning unit 200, and support query of types, a quantity, loading/unloading requirements, physical properties, chemical properties, physical and chemical hazards, and corresponding emergency rescue guide information of goods that are currently transported.

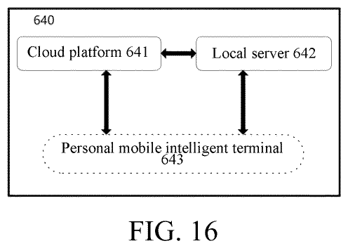

Referring to FIG. 16, FIG. 16 is a schematic diagram of a composition of a communication center 640 of a remote management unit 600 of a safety protection system for a freight automobile and on-board goods provided in this example.

As shown in FIG. 16, the communication center 640 of the remote management unit 600 provided in this example includes a cloud platform 641, a local server 642, and a personal mobile intelligent terminal 643. In this example, the communication center application mode of combining the cloud platform 641 with the personal mobile intelligent terminal 643 is preferred, which may be determined according to actual communication conditions of different users, and is not limited herein.

As shown in FIG. 1, FIG. 12, and FIG. 16, the cloud platform 641 of the communication center 640 is configured to store data information and alarm information uploaded by an on-board gateway unit 400, receive data of the government industry management client software 610/the enterprise operation management client software 620/the driver and passenger service client software 630, invoke a shared data resource pool, and support communication interaction among a computer hardware platform environment to which the government industry management client software 610/the enterprise operation management client software 620/the driver and passenger service client software 630 is applied, the government industry management client software 610/the enterprise operation management client software 620/the driver and passenger service client software 630, and the on-board gateway unit 400. The cloud platform 641 communicates with the on-board gateway unit 400, and is configured to receive and store the on-board goods anti-theft and anti-robbery monitoring and warning information forwarded by the anti-theft and anti-robbery monitoring and warning unit 200 through the on-board gateway unit 400, and forward management commands or reply commands of the government industry management client software 610, the enterprise operation management client software 620, and the driver and passenger service client software 630 to the on-board gateway unit 400. As an example, the cloud platform 641 herein supports application of a B/S monitoring client, and the B/S monitoring client is preferably developed based on the latest version of a high-security operating system and a high-security browser (Xin Chuang version).

The local server 642 of the communication center 640 is configured to store data information and alarm information uploaded by the on-board gateway unit 400, receive data of the government industry management client software 610/the enterprise operation management client software 620/the driver and passenger service client software 630, invoke a data resource pool, and support communication interaction among a computer hardware platform environment to which the government industry management client software 610/the enterprise operation management client software 620/the driver and passenger service client software 630 is applied, the government industry management client software 610/the enterprise operation management client software 620/the driver and passenger service client software 630, and the on-board gateway unit 400. The local server 642 communicates with the on-board gateway unit 400, and is configured to receive and store the on-board goods anti-theft and anti-robbery monitoring and warning information forwarded by the anti-theft and anti-robbery monitoring and warning unit 200 through the on-board gateway unit 400, and forward management commands or reply commands of the government industry management client software 610, the enterprise operation management client software 620, and the driver and passenger service client software 630 to the on-board gateway unit 400. As an example, the local server 642 herein supports application of a C/S monitoring client, and the C/S monitoring client is developed based on various latest versions of high-security operating systems of the Linux kernel.

The personal mobile intelligent terminal 643 of the communication center 640 is configured to store data information and alarm information uploaded by the on-board gateway unit 400, and is configured as an online query tool and a temporary storage space of the uploaded data information for the government industry management client APP software 610/the enterprise operation management client APP software 620/the driver and passenger service client APP software 630, and supports communication interaction among a microcomputer hardware platform environment to which the government industry management client APP software 610/the enterprise operation management client APP software 620/the driver and passenger service client APP software 630 is applied, the government industry management client APP software 610/the enterprise operation management client APP software 620/the driver and passenger service client APP software 630, and the on-board gateway unit 400.

Further, the personal mobile intelligent terminal 643 can further communicate with the on-board gateway unit 400 through the cloud platform 641 or the local server 642, and is configured to receive and store the on-board goods anti-theft and anti-robbery monitoring and warning information forwarded by the anti-theft and anti-robbery monitoring and warning unit 200 through the on-board gateway unit 400, and forward a management command or reply command or emergency rescue guide information of the government industry management mobile client APP software 610/the enterprise operation management mobile client APP software 620/the driver and passenger service mobile client APP software 630 to the on-board gateway unit 400. As an example, the mobile monitoring client APP herein is preferably developed based on an operating system based on the Linux kernel such as the HarmonyOS microkernel or Android.

During the deployment, the remote management unit 640 configured accordingly is preferably arranged on a cloud platform of a competent government department related to vehicle traffic management or operation management and/or a local storage server and/or a personal hand-held intelligent terminal of a relevant management person, a cloud platform of a transportation enterprise to which the vehicle belongs and a transportation-related party and/or a local storage server and/or a personal hand-held intelligent terminal of a relevant management person, and a personal hand-held intelligent terminal of a driver and passenger, is associated with the on-board gateway unit 400, and is indirectly associated with the anti-theft and anti-robbery monitoring and warning unit 200 and the alarm prompt unit 500 through the on-board gateway unit 400.

The remote management unit 640 deployed in this way can receive the on-board goods anti-theft and anti-robbery monitoring and warning information sent by the on-board gateway unit, provide a driver management operation command based on the alarm information, and feed back the driver management operation command to the on-board gateway unit and to the alarm prompt unit through the on-board gateway unit. The remote management unit supports setting and adjusting a warning and alarm threshold and an information uploading frequency of the relevant monitoring device of the anti-theft and anti-robbery monitoring and warning unit through the relevant monitoring client software, and pushes emergency rescue guide information for goods transport.

The safety protection system for a freight automobile and on-board goods formed based on the specific scheme provided in this example can automatically monitor the anti-theft and anti-robbery safety information of on-board goods during operation, give an acousto-optic warning and alarm or voice prompt to the driver and passenger when there is a risk of theft and robbery of on-board goods, prompt the driver and passenger to get off in time for inspection or security preparation or positioning and tracking, push and play voice prompt or file guide for emergency response on the spot, and help the driver and passenger start emergency response quickly.

On this basis, the system is further equipped with a remote management unit, so that the anti-theft and anti-robbery monitoring information can be linked with the competent industry departments and subordinate units in real time. This buys time for early deployment of emergency rescue and anti-terrorism prevention forces, and quick start of emergency rescue and anti-terrorism investigation while assisting the driver and passenger with on-site response and preventing accidents.

Finally, it needs to be noted that according to the above method of the present invention, a specific system unit or some units thereof may be deployed on a physical medium through program code, such as a hard disk, an optical disc, or any electronic device (such as a smart phone and a computer-readable storage medium). When a machine loads and executes the program code (for example, a smart phone loads and executes the program code), the machine becomes a device for implementing the present invention. The above method and device of the present invention may also be transmitted through some transmission media in the form of program code, such as a cable, an optical fiber, or any transmission mode. When the program code is received, loaded, and executed by a machine (such as a smart phone), the machine becomes a device for implementing the present invention.

The basic principle, main features, and advantages of the present invention are shown and described above. It should be understood by a person skilled in the art that the present invention is not limited by the above embodiments, and what is described in the above embodiments and description is only the principles of the present invention. Various changes and improvements can also be made in the present invention without departing from the spirit and scope of the present invention, which shall fall within the scope of the claimed present invention. The protection scope of the present invention is defined by the appended claims and their equivalents.

What is claimed is:

1. A safety protection system for a freight automobile and on-board goods, comprising:
an anti-theft and anti-robbery monitoring and warning unit, wherein the anti-theft and anti-robbery monitoring and warning unit is associated with an on-board gateway unit, and is associated with an alarm prompt unit and a remote management unit through the on-board gateway unit; and the anti-theft and anti-robbery monitoring and warning unit is configured to:
monitor anti-theft and anti-robbery safety information of the on-board goods in real time, perform theft and robbery risk warning analysis on the vehicle loaded with goods and the goods on the vehicle directly or in cooperation with the on-board gateway unit based on the monitored information, generate warning information for a risk, send the warning information to the remote management unit through the on-board gateway unit, and send a warning through the alarm prompt unit;
the on-board gateway unit, wherein the on-board gateway unit is respectively associated with the anti-theft and anti-robbery monitoring and warning unit, the alarm prompt unit, and the remote management unit, and establishes a communication channel with the units to complete data exchange, and the on-board gateway unit is configured to store data information acquired by functional modules of the on-board gateway unit and complete the risk warning analysis based on the relevant data information in cooperation with the anti-theft and anti-robbery monitoring and warning unit;
the alarm prompt unit, wherein the alarm prompt unit is connected to the on-board gateway unit, and is configured to complete a local alarm on the automobile and/or complete a remote alarm through the remote management unit associated with the on-board gateway unit; and
the remote management unit, wherein the remote management unit is associated with the on-board gateway unit, and is indirectly associated with the anti-theft and anti-robbery monitoring and warning unit and the alarm prompt unit through the on-board gateway unit, and the remote management unit is configured to form system configuration information and/or emergency handling information, and is further configured to receive on-board goods anti-theft and anti-robbery monitoring and warning information sent by the on-board gateway unit.

2. The safety protection system for a freight automobile and on-board goods according to claim 1, wherein the anti-theft and anti-robbery monitoring and warning unit comprises one or more of an automobile anti-theft alarm module, an automobile anti-robbery monitoring module, an automobile anti-theft and anti-robbery positioning and tracking module, a vehicle fuel tank safety monitoring module, an access intrusion detection module, a goods anti-theft video monitoring module, and/or an automatic goods inventory module, monitoring data of each module is aggregated to the on-board gateway unit, the anti-theft and anti-robbery risk warning analysis is performed through the on-board gateway unit, and when a corresponding anti-theft and anti-robbery warning is triggered, a corresponding warning is sent to the alarm prompt unit through the on-board gateway unit, and the alarm prompt information is uploaded to the remote management unit through the on-board gateway unit;
the automobile anti-theft alarm module comprises a direct contact sensor and/or a current and voltage drop sensor and/or an ultrasonic sensor and/or a microwave sensor and/or a shock sensor and/or a tilt sensor, and is configured to monitor an illegal position movement or an abnormal start of the vehicle in a parked state, and transmit monitoring information to a data storage module and an edge computing module of the on-board gateway unit or to the remote management unit through a network communication module of the on-board gateway unit;
the automobile anti-robbery monitoring module comprises one or more of an exterior video monitoring device, a concealed alarm button, a wireless transmitting pinhole camera, a warning light, an exterior tear gas sprayer, and another self-defense weapon, and is configured to monitor conditions such as an armed person around the vehicle and gathering of abnormal persons, and transmit monitoring information to the on-board gateway unit or to the remote management unit through the on-board gateway unit;
the automobile anti-theft and anti-robbery positioning and tracking module comprises one or more of a deep sleep tracking locator, a solar charger, and an infrared pinhole camera at an automobile driver position, and is configured to locate and track a real-time position of the vehicle after an anti-theft and anti-robbery alarm is triggered, and transmit the tracked positioning information to the remote management unit through the on-board gateway unit;
the vehicle fuel tank safety monitoring module comprises one or more of an infrared detector and a vibration sensor arranged on a fuel tank cap, a liquid level sensor arranged in a fuel tank, and/or an infrared pinhole camera configured to monitor a position of the fuel tank in real time, and is configured to perform real-time video monitoring on the position of the fuel tank of the freight vehicle loaded with goods, and transmit monitoring information to the on-board gateway unit or directly to the remote management unit through the on-board gateway unit;
the access intrusion detection module comprises one or more of an access controller, a passive infrared intrusion detector and/or an active infrared intrusion detector and/or a microwave intrusion detector and/or a radar microwave detector and/or a switch detector and/or an ultrasonic detector and/or a voice control detector and/or a wireless magnetic switch detector, a vibration sensor, and a pinhole camera configured to monitor a position of a compartment door of the freight vehicle or an oil pump inlet and outlet pipeline/oil drain valve of a tank car in real time, which are arranged on the compartment door of the freight vehicle carrying goods or the oil pump inlet and outlet pipeline/oil drain valve of the tank car, and is configured to monitor the compartment door of the freight vehicle loaded with goods or the oil pump inlet and outlet pipeline/oil drain valve of the tank car, and transmit monitoring information to the on-board gateway unit or directly to the remote management unit through the board gateway unit;
the goods anti-theft video monitoring module comprises a goods image monitoring camera arranged above four corners in a compartment and a process monitoring camera arranged in the compartment exactly facing the compartment door, and is configured to perform video monitoring on a goods condition inside a closed van loaded with goods and all openings of the tank car, and transmit monitoring information to the on-board gateway unit or directly to the remote management unit through the on-board gateway unit; and
the automatic goods inventory module comprises a code scanner or a radio frequency identification reader arranged at the compartment door, and a barcode label, a two-dimensional code label, or a radio frequency identification label arranged on a goods package, and is configured to record a change in a number of goods during loading and unloading in real time, perform regular or irregular inventory on a number of carried goods, and transmit recording and inventory information to the on-board gateway unit or directly to the remote management unit through the on-board gateway unit.

3. The safety protection system for a freight automobile and on-board goods according to claim 1, wherein the on-board gateway unit comprises a network communication module and/or a data storage module and/or an edge computing module;
the network communication module comprises one or more of a 5G communication device, a CAN bus communication device, a TCP/IP communication device, a Bluetooth communication device, and another wireless communication device, and is configured for data exchange between the anti-theft and anti-robbery monitoring and warning unit and a goods transportation emergency rescue guide unit and the alarm prompt unit and the remote management unit;
the data storage module comprises a built-in data storage device and an external data storage device, and is configured to store the monitoring information uploaded by the anti-theft and anti-robbery monitoring and warning unit; and
the edge computing module comprises an AI smart chip with an edge computing function and a terminal SDK with the edge computing function, and is configured to perform intelligent analysis and determination based on the monitoring information uploaded by the anti-theft and anti-robbery monitoring and warning unit.

4. The safety protection system for a freight automobile and on-board goods according to claim 1, wherein the on-board gateway unit is directly associated with the anti-theft and anti-robbery monitoring and warning unit, the alarm prompt unit, and the remote management unit;
when the on-board gateway unit receives the monitoring information of the anti-theft and anti-robbery monitoring and warning unit and triggers a related goods theft and robbery warning and alarm based on a result of the analysis and determination based on the monitoring information, the on-board gateway unit sends an acousto-optic alarm or voice prompt information to the alarm prompt unit and sends warning and alarm information and real-time monitoring information to the remote management unit; and
when receiving an alarm command, a voice prompt command, or an alarm threshold setting adjustment sent by the remote management unit, the on-board gateway unit sends the alarm command and the voice prompt command information to the alarm prompt unit, and sends command information such as the alarm threshold setting adjustment and circuit control to a relevant monitoring device of the anti-theft and anti-robbery monitoring and warning unit to perform a relevant operation such as adjusting an alarm threshold of a monitoring sensor and starting the positioning and tracking device or a related pinhole camera.

5. The safety protection system for a freight automobile and on-board goods according to claim 1, wherein the alarm prompt unit comprises a vehicle local alarm prompt subunit and a remote monitoring client software alarm prompt subunit.

6. The safety protection system for a freight automobile and on-board goods according to claim 1, wherein
the remote management unit comprises a government industry management client software, an enterprise operation management client software, a driver and passenger service client software, and a communication center;
the government industry management client software is configured to: receive and display high-risk-level automobile and on-board goods anti-theft and anti-robbery monitoring and warning information forwarded by the anti-theft and anti-robbery monitoring and warning unit through the on-board gateway unit and the communication center, send a relevant management command based on the received warning and alarm information, start an emergency management process, and issue a relevant emergency response command;
the enterprise operation management client software is configured to: receive and display automobile and on-board goods anti-theft and anti-robbery monitoring and warning information forwarded by the anti-theft and anti-robbery monitoring and warning unit through the on-board gateway unit and the communication center, send a relevant management command or emergency rescue guide information based on the received warning and alarm information, and start an emergency management process, give an emergency alarm; and issue a relevant emergency response command to the government industry management client when receiving the high-risk-level automobile and on-board goods anti-theft and anti-robbery monitoring and warning information;
the driver and passenger service client software is configured to: receive and display the automobile and on-board goods anti-theft and anti-robbery monitoring and warning information forwarded by the anti-theft and anti-robbery monitoring and warning unit through the on-board gateway unit and the communication center, send an acousto-optic alarm, a voice prompt, and an emergency rescue guide corresponding to the alarm and warning information based on the received alarm and warning information, prompt a driver to stop nearby or stop immediately for inspection, and provide a corresponding emergency response guideline; and
the communication center is configured to communicate with the on-board gateway unit, receive and store the automobile and on-board goods anti-theft and anti-robbery monitoring and warning information forwarded by the anti-theft and anti-robbery monitoring and warning unit through the on-board gateway unit, and forward the automobile and on-board goods anti-theft and anti-robbery monitoring and warning information to the government industry management client software, the enterprise operation management client software, and the driver and passenger service client software respectively.

7. The safety protection system for a freight automobile and on-board goods according to claim 6, wherein the remote management unit comprises a government industry management client, an enterprise operation management client, a driver and passenger service client, and a communication center;
the government industry management client of the remote management unit comprises a public security industry management client software, a traffic industry management client software, an emergency industry management client software, and another industry management client software depending on different competent industry departments;
the enterprise operation management client of the remote management unit comprises a consignment unit management client software, a carrier unit management client software, and a receiving unit management client software depending on different users;
the driver and passenger service management client of the remote management unit comprises a driver service client software, an escort service client software, and a stevedore service client software depending on different users; and
the communication center of the remote management unit comprises a cloud platform, a local server, and a personal mobile intelligent terminal.

8. The safety protection system for a freight automobile and on-board goods according to claim 1, wherein the remote management unit is arranged on a cloud platform of a competent government department related to vehicle traffic management or operation management and/or a local storage server and/or a personal hand-held intelligent terminal of a relevant management person, a cloud platform of a transportation enterprise to which the vehicle belongs and a transportation-related party and/or a local storage server and/or a personal hand-held intelligent terminal of a relevant management person, and a personal hand-held intelligent terminal of a driver and passenger, is associated with the on-board gateway unit, and is indirectly associated with the anti-theft and anti-robbery monitoring and warning unit and the alarm prompt unit through the on-board gateway unit.

9. The safety protection system for a freight automobile and on-board goods according to claim 3, wherein the on-board gateway unit is directly associated with the anti-theft and anti-robbery monitoring and warning unit, the alarm prompt unit, and the remote management unit;
when the on-board gateway unit receives the monitoring information of the anti-theft and anti-robbery monitoring and warning unit and triggers a related goods theft and robbery warning and alarm based on a result of the analysis and determination based on the monitoring information, the on-board gateway unit sends an acousto-optic alarm or voice prompt information to the alarm prompt unit and sends warning and alarm information and real-time monitoring information to the remote management unit; and
when receiving an alarm command, a voice prompt command, or an alarm threshold setting adjustment sent by the remote management unit, the on-board gateway unit sends the alarm command and the voice prompt command information to the alarm prompt unit, and sends command information such as the alarm threshold setting adjustment and circuit control to a relevant monitoring device of the anti-theft and anti-robbery monitoring and warning unit to perform a relevant operation such as adjusting an alarm threshold of a monitoring sensor and starting the positioning and tracking device or a related pinhole camera.
